(19) United States
(12) Patent Application Publication
(10) Pub. No.: US 2014/0379589 A1
(43) Pub. Date: Dec. 25, 2014

(54) SYSTEM AND METHOD FOR DISPUTE RESOLUTION

(71) Applicant: Paul Ratcliffe, Broadlands, VA (US)

(72) Inventor: Paul Ratcliffe, Broadlands, VA (US)

(21) Appl. No.: 14/314,860

(22) Filed: Jun. 25, 2014

Related U.S. Application Data
(60) Provisional application No. 61/838,882, filed on Jun. 25, 2013.

(51) Int. Cl. G06Q 50/18; G06F 3/0484; G06F 3/0481

(52) U.S. Cl. CPC G06Q 50/182; G06F 3/04817; G06F 3/04847
USPC 705/309

(57) ABSTRACT

The invention provides a dispute resolution platform comprising servers, software, data, and communication capabilities providing a user interface and systems enabling live settlement, live decisions, and live feedback from a group of users who are not a party to the dispute. The present invention provides an online dispute resolution platform enabling parties to describe their dispute, upload evidence, comments, testimony, affidavits and comments from witnesses through a system which identifies opportunities for settlement and prompts users. The system allows the parties to settle their dispute prior to a live hearing, during a live hearing, or after a live hearing,

### RELATED APPLICATION

This application claims priority to U.S. Provisional Patent Application 61/838,882 filed on Jun. 25, 2013, entitled “System and Method for Dispute Resolution and Simulated Trials in a Virtual Setting”, the entirety of which is incorporated herein.

### BACKGROUND OF THE INVENTION

The present invention relates to a system for providing dispute resolution in a virtual setting by one or a group of users with decision-making authority and for conducting mock trials with vast numbers of jury members.

### SUMMARY OF THE INVENTION

This summary of the invention is provided to introduce concepts in a simplified form that are further described in the detailed description of the invention. This summary is not intended to identify key or essential inventive concepts of the claimed subject.

The present invention provides for a software program designed to facilitate the resolution of disputes between two or more individuals or parties through a system of servers, software or computer applications and various databases which provide a user interface and system where the decision-making authority is vested with a user or group of users who are not a party to the dispute. The present invention incorporates the use of a system with user interfaces, software and databases which allow the parties in dispute the opportunity to describe their dispute, upload evidence, comments, and testimony or affidavits and comments from witnesses (who may be registered users of the system) that supports their positions (collectively the “evidence”). The evidence is then reviewed by a user or a group of users as part of its effort to render a final decision.

The present invention also provides a system for providing online dispute resolution, comprising at least one processor; a database for storing a plurality of information including information on at least one dispute; and a computer-readable storage medium storing one or more sequences of instructions which, when read by the at least one processor, causes the system to: receive a first audio and video feed from a plaintiff user; receive a second audio and video feed from a defendant user; display the first feed and second feed on a jury user interface to at least one jury user; receive electronic feedback from the at least one jury user on who they think should prevail in the dispute; average the electronic feedback from the at least one jury user and display the averaged feedback on a plaintiff user interface and a defendant user interface; allow the plaintiff user to enter a plaintiff settlement amount on the plaintiff user interface; allow the defendant user to enter a defendant settlement amount on the defendant user interface; and notify the plaintiff user and defendant user if the plaintiff settlement amount and defendant settlement amount cross such that a settlement amount is reached. The system may incorporate a feedback which employs a moveable icon positioned along a sliding scale wherein the average calculation is based on the average position of the icon along the sliding scale. Further, the system may receive a third audio and video feed from an arbitrator user; displays the first feed, second feed, and third feed on the plaintiff user interface, the defendant user interface, and the arbitrator user interface; and displays the real time plaintiff settlement amount, the real time defendant settlement amount, and the averaged feedback on the arbitrator user interface.

The present invention also provides an online dispute resolution system comprising: at least one processor; a database for storing a plurality of information including information on at least one dispute; and a computer-readable storage medium storing one or more sequences of instructions which, when read by the at least one processor, causes the system to: receive a first audio and video feed from a plaintiff user; receive a second audio and video feed from a defendant user; receive a third audio and video feed from an arbitrator user; display the first feed, second feed, and third feed on a plaintiff user interface, a defendant user interface, and an arbitrator user interface; allow the plaintiff user to enter a real time plaintiff settlement amount on the plaintiff user interface; allow the defendant user to enter a real time defendant settlement amount on the defendant user interface; and display both the real time plaintiff settlement amount and the real time defendant settlement amount on the arbitrator user interface.

These and other objects, features, and/or advantages may accrue from various aspects of embodiments of the present invention, as described in more detail below.

### BRIEF DESCRIPTION OF THE DRAWINGS

The foregoing summary, as well as the following detailed description of the invention, is better understood when read in conjunction with the appended drawing. For the purpose of illustrating the invention, exemplary constructions of the invention are shown in the drawings. However, the invention is not limited to the specific methods and instrumentalities disclosed herein.

FIG. 1 exemplarily illustrates a flow diagram of the present invention; and

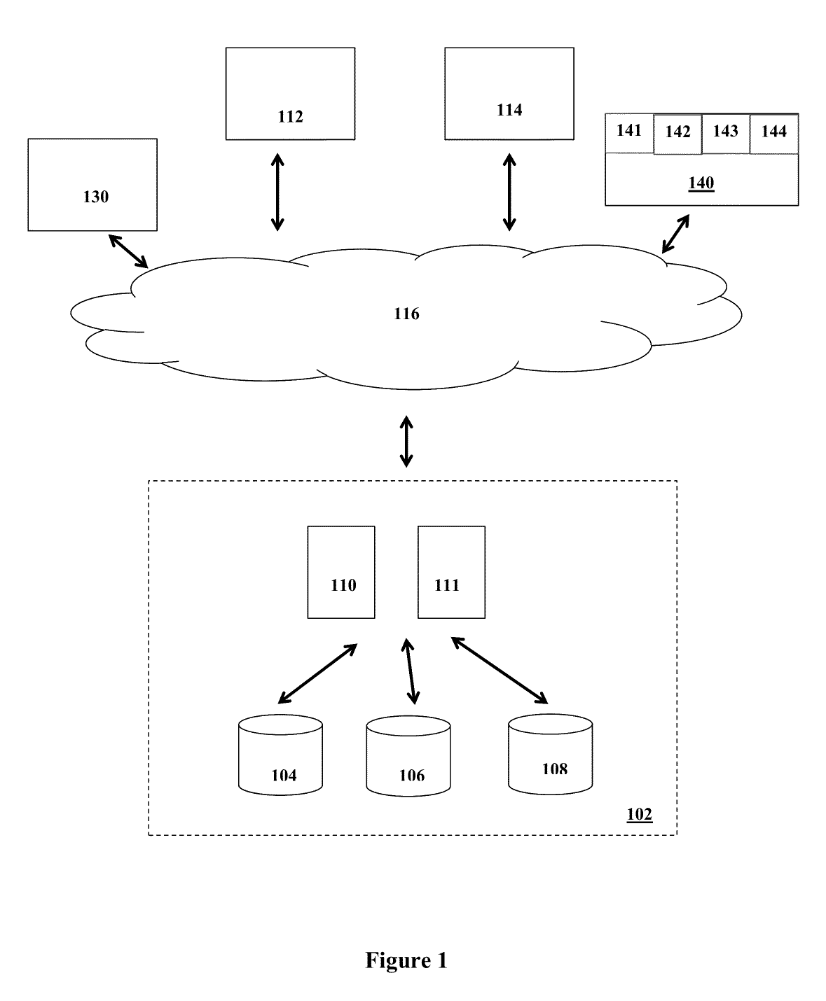

FIG. 2 provides an exemplary illustration of a screen diagram of the conference function of the present invention.

### DETAILED DESCRIPTION OF EXEMPLARY EMBODIMENTS

Particular embodiments of the present invention will now be described in greater detail with reference to the figures.

The present invention provides for a software based system 102 designed to facilitate dispute resolution between two or more parties 112, 114 through a format where the decision-making authority is vested with a user or group of users which are not a party to the dispute. The software based system 102 includes one or more software applications which interact with one or more databases 104, 106, 108 and one or more servers 110, 111. They system 102 may be designed to operate as one or more of the following: a mobile application; a web-based application; a website; or an application integrated with other networks, i.e., Google+ and Facebook.

The system 102 and the one or more servers 110, 111 and one or more databases 104, 106, 108 may be accessed via the internet 116.

The databases 104, 106, 108 of the system 102 may be comprised of: (1) one or more databases or tables 104 used to store information related to a group of users with decision-making authority (hereinafter referred to as the “decider pool database”); (2) one or more databases or tables 106 used to store information related to the dispute and the evidence, i.e., documents, images, and videos (hereinafter referred to as the “evidence database”); and (3) one or more databases or tables 108 used to store information related to dispute information and agreements (hereinafter referred to as the “related information database”). The system 102 would include all software to allow the parts of the system to interact and the graphics processing to provide appropriate graphics and user interface to allow the parties in dispute and the users to interact with each other and the system. In an exemplary embodiment, the system 102 will utilize Web-RTC for browser based video-conferencing.

The parties would log into the system 102 via the internet 116 and submit a dispute that the parties would like resolved by a user or group of users whom the parties in dispute have granted decision-making authority. The user may be a judge, retired judge, arbitrator or lawyer, or a family member who the parties have agreed should settle the dispute. The group of user may be friends of the disputing parties 112, 114 such as friends on Facebook or google+ or they may be random or selected users for a user pool (i.e. jury pool).

The decider pool database 108 allows the parties 112, 114 to pick a user, i.e., a judge, mediator, arbitrator, lawyer, or family member 130 they want to resolve their dispute or to pick a group of users 140, i.e., a jury pool 141, 142, 143, 144, to be given the authority to render a final decision to the dispute (hereinafter referred to as the “decision-makers”). By way of example, the judges, arbitrators, or mediators 130 could be retired members of the court looking for a supplementary source of income and would be compensated by the parties 112, 114 for their time or compensated for a share of revenue from advertising. The jury pool 140 could be made up of friends 141, 142 (such as Facebook friends) or random or anonymous users 143, 144 of the system.

The parties 112, 114 can virally invite third-party individuals (such as fiends) to be a part of the decision-making group or they can select a group at random. Invitations, for example, can be sent via email, Facebook messages, Facebook share functions, mobile push notifications, twitter, and other social media sharing mechanisms.

The system provides the ability for the parties 112, 114 to each select one or more the judges, arbitrators, or mediators 130 and when the parties have selected a matching judge, arbitrator, or mediator the decision-making user 130 is chosen. In addition, the system can allow each user to select an equal number of jury pool members 140. The jury pool members 140 could be friends of the disputing parties 112, 114.

Once a pool of decision-makers is assembled 140, the parties 112, 114 can engage in a voir dire process in which they will be given the opportunity to strike members of the jury pool 140 in an attempt to create a final list of decision-makers. They can strike members of the decision-making pool for a variety of reasons, including, but not limited to: (1) the member of the pool may have an interest in the outcome of the dispute, (2) the member of the pool may possess certain characteristics, such as sex, age, race, political affiliation, religion, and occupation, that may result in a perceived bias in favor of one of the parties 112, 114; or (3) the member may be too closely associated with one of the decision makers. The number of strikes given to each party can be set and decided upon before this voir dire process takes place. The voir dire and strike process may be based solely on the user's profile which could include their sex, age, race, political affiliation, religion, and occupation or on an open dialogue between the disputing parties and the jury pool users. The final group of decision-makers would be paired down until it matches the pre-selected number of jury pool users (i.e. six, twelve, or more jury role users).

The jury pool members 140 may remain anonymous to the disputing parties to avoid any ex-parte discussions and to allow the jury pool users 141, 142, 143, 144 to feel confident to make comments and decisions without concern of retribution or influence. Further, the decision making users 141, 142, 143, 144 could have ratings as jury members related to number of cases completed, timeliness in responding to stages of the dispute process, their intellect, contributions to resolving the disputes, and their interaction with other users. The jury members might also receive compensation for being a member. Such compensation might be a payment from the disputing parties 112, 114 or it might be in the form of advertisements presented by sponsors of the system, website or show.

The system might also allow the disputing parties 112, 114 to use both a judge 130 and a jury 140. The judge 140 may be in place to run the proceedings and interpret the law, legal implications, and any judge related decisions and the jury 140 is there to decide any jury relevant decisions such as whether the plaintiff or defendant is more believable and the amount of damages.

The system would allow various graphic options which would allow the parties to determine the layout of the virtual room in which the dispute would take place. For example, the virtual room could look like a courtroom with avatars that represent the disputing parties 112, 114, the jury 140, and judge 130, or the room could look like a mediation room with the parties and the mediator sitting at a table.

The evidence database 106 allows the parties to upload evidence such as documents, images, audio clips and videos that support their position in the dispute. For example, the parties 112, 114 may submit a short memorandum in support of their position and even record a visual or audio opening statement. Once the evidence is submitted, it is reviewed by the decision-maker or group of decision-makers as part of its effort to render a final decision. Note, the parties 112, 114, and the judge 130 could be capable of providing live or recorded audio or video (web-cam) statements or testimony. The live testimony or web-cam activity can also be recorded and transcribed by the system. In an exemplary embodiment, the judge, plaintiff, and defendant are each live on one web screen (i.e. via Web-RTC) for a live conference of the dispute. The live conference is transmitted to the jury users for their real time engagement and feedback.

Once the evidence for a given dispute is reviewed, the decision-makers will discuss, debate, and vote on the final resolution of the dispute. This may occur in a separate virtual room, i.e., jury room, in which only the members 141, 142, 143, 144 of the decision-making group 140 are allowed access to. The jury pool 140 might also have a private chat window which only they can see or view (which disputing parties cannot see)—during live testimony (or during live chats) so they can discuss their real time thoughts amongst each other.

Once a final resolution has been determined, the decision-makers will announce the decision to the parties and anyone else who has decided to view the case in the designated public view area. The entire process can remain confidential with access limited to only those parties the disputing parties 112, 114 want to allow access to. Further, all parties including the disputing parties 112, 114 can remain anonymous like the decision making jury pool members 141, 142, 143, 144. The decision making judge or arbitrator 140 may not want to remain anonymous so that he can build a reputation for his ability at resolving disputes.

The system 102 can also be adapted to provide contractually binding agreements for use with the process such that the disputing parties agree to be contractually bound by the decision of the judge/arbitrator 130 or the jury 140. Therefore, the system 102 can be used to resolve actual legal disputes among parties.

Further, the system can limit the jury pool to local users in an effort to find a true jury of peers. The judge or arbitrator can also be limited to local (state and or county) judges who are familiar with the laws of the jurisdictions of the disputing parties. Further, the judges may be limited to specialties such as personal injury or landlord-tenant matters.

The system could also have a significant benefit to conduct mock-trials of cases headed to actual state or federal hearings. Such would give excellent insight into how the judge 130 and jury 140 react to certain information, remarks, language and strategies. For example, a litigator might use the system to conduct mock trials to determine: (1) is an argument persuasive; and (2) is a witness (i.e. and expert witness) credible. In such mock trials, the jury room conversation may be viewable to the parties 112, 114 or the attorney for one of the parties if it's a mock trial. Further, the mock trial could be conducted in front of a large jury pool, either live or through a taped session, where the jury is asked to decide or provide feedback. The feedback might be general or specific responses to asked questions. The backend system 102 can then identify all the users and their demographic profiles including age, race, religion, sex, political affiliations, and other factors and provide a true analytic report or data of jury members profiles that are open to their arguments and those which might be more inclined to not find for their client.

Further, if a litigator has an active case with a known jury profile, the jury can be replicated through the jury user pool and 1 or many instances of a similar jury pool can be created. The attorney can then test out various strategies against different jury pools to determine which language, experts, and strategies are best for the actual jury pool. Depending on scheduling of the real trial, the mock trial may be run simultaneously with the real trial or in the evening to test our trial strategies for the next day.

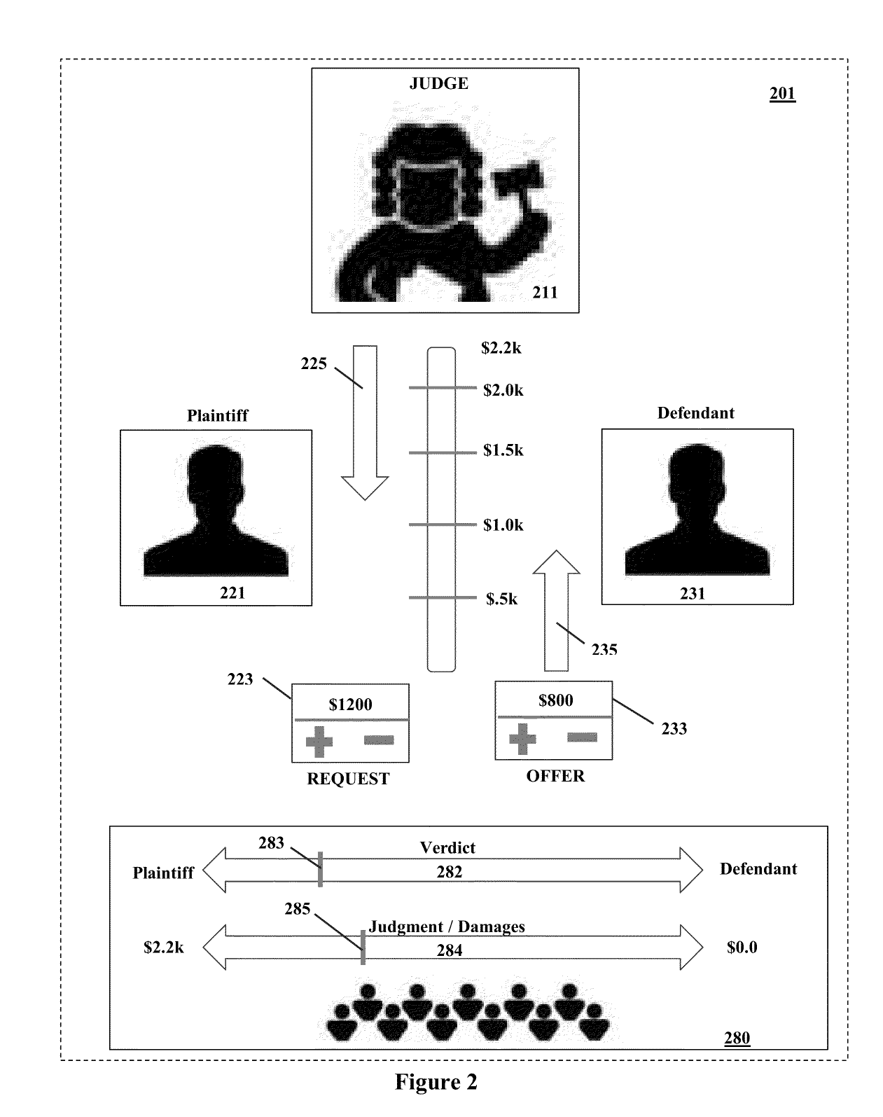

FIG. 2, provides a sample screen capture of the system of the present invention showing the conference room. The screen capture 201 provides a graphical user interface of the conference room. The screen 201 displays a judge or arbitrator window 211, a plaintiff window 221, and a defendant window 231. In the windows 211, 221, 231 are live camera feeds displaying the various parties. The live feeds are primarily web based camera feeds from a user laptop, tablet, or a video camera connected to a computer or the web. In a preferred embodiment, the system uses Web-RTC which allows browser based high definition quality video signals. The judge 211, plaintiff 221, and defendant 231 can all see each other.

Integrated into the dispute conference or arbitration hearing is a settlement feature. In an exemplary embodiment, the feature includes a moveable or sliding settlement amount for both the plaintiff 221 and defendant 231. The plaintiff 221 when filing the dispute is seeking or requesting a judgment and/or damages in a set amount. The amount is shown on the request bar which may show graphical indicia of the total amount sought. The plaintiff 221 has a request window 223 which shows the current amount requested and ability to raise or lower the request amount. As the user moves the requested amount up or down the plaintiff's settlement bar 225 moves in relation to the entire amount originally sought. Thus, as a the plaintiff is pleading their case or hearing the defendant defend the case, or seeing the jury feedback the plaintiff may decide he is willing to request less than originally sought to avoid losing or winning less. In the example on the screen capture 201, the plaintiff originally sought $2200.00 but has lowered the request to $1200 after engaging with the system and other users. The plaintiff 221 can change the request in real time as the live dispute resolution is progressing.

Similarly, the defendant 231 has an offer window 233 which shows the current amount defendant has offered to settle the dispute along with the ability to raise or lower the offer amount. As the user moves the offer amount up or down the defendant's settlement bar 235 moves in relation to the entire amount originally sought. Thus, as a the defendant is pleading their case or hearing the plaintiff plead their case, or seeing the jury feedback the defendant may decide he is willing to offer more money to settle the dispute and to reduce the possibility of losing more. In the example on the screen capture 201, the defendant is present to a $0 offer but has raised the offer to $800 after engaging with the system and other users. The defendant 231 can change the request in real time as the live dispute resolution is progressing. In the event the plaintiff's 221 request amount 223 or bar 225 crosses the amount offered 233 or offer line 235 an instant settlement is reached.

In addition, the system may incorporate a jury pool 280. The jury pool users 280 are provided a live feed or feeds of the judge 211, plaintiff 221, and defendant 231 and watch and interact as the dispute is heard. In one exemplary embodiment, the jury 280 are provided the opportunity to provide live feedback to the judge 211, plaintiff 221, and defendant 231 via one or more feedback bars 282, 284. Feedback bar 282 is a verdict bar which allows the jury members to enter their opinion as to who they think is winning the dispute (during the dispute) or who they think should win the dispute as the dispute is completed but waiting for a decision from the arbitrator. Each jury member would slide their persuasion line 283 along the verdict bar 282 indicating which side they believe should win. The verdict bar 282 may have additional labels to assist the jury members how far to slide the bar (i.e. plaintiff is somewhat believable, very believable, plaintiff should win). In addition, the jury 280 may have a second judgment or damages bar 284. The judgment bar 284 would be used for each jury member to slide the judgment line 285 along the judgment bar 284 to the amount of damages they would award and to which party. In the preferred embodiment, the judgment bar 285 would be preset with the damages amount sought by plaintiff 221 such that incremental movement of the judgment line 285 would have an associated amount.

An important aspect of the present invention is the system 102's ability to show different user's different aspects or features so as to not taint the other user's opinions. Specifically, the jury 280 is not shown the settlement bars 225, 235 since the jury members may be inclined to move their verdict 282 and judgment 284 bars in an effort to accelerate a settlement. Further, the jury would not be shown the verdict and judgment bars 282, 284 and associated opinion lines 283, 285 of the other jury members, or the cumulative total, so as to not be swayed by other jury members. In this manner, each jury member is truly making an independent decision.

However, the plaintiff 221 and defendant 231 may be shown the cumulative jury opinions as such may encourage settlement by encouraging the plaintiff and/or defendant 231 to move their settlement request 223, 225 or offer 233, 235. Further, the plaintiff 221 would not see the defendant's offer bar 233, 235 and the defendant 231 would not see the plaintiff's offer bar 223, 235. The judge/arbitrator 211 may see the plaintiff's offer bar 223, 235, the defendant's offer bar 233, 235, and the cumulative jury opinions as a means to help him get the plaintiff 221 and defendant 231 to reach a settlement.

In the event a settlement is not reached, in an exemplary embodiment, the judge 211 would hear the case, consider the jury's cumulative opinion and render a decision. Alternatively, the plaintiff 221 and defendant 231 may decide prior to the real time web conference dispute, to let the jury decide the verdict and the judgment or damages amount. Whether the parties reach a settlement or a decision is made the decision is memorialized in user selected binding or non-binding contracts. The system 102 would prepopulate e-signatures and language from the judge's decision into standard agreements for the location of the parties and dispute.

The examples provided herein are merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

I claim:

1. A system for providing online dispute resolution, comprising:
at least one processor;
a database for storing a plurality of information including information on at least one dispute; and
a computer-readable storage medium storing one or more sequences of instructions which, when read by the at least one processor, causes the system to:
receive a first audio and video feed from a plaintiff user;
receive a second audio and video feed from a defendant user;
display the first feed and second feed on a jury user interface to at least one jury user;
receive electronic feedback from the at least one jury user on who they think should prevail in the dispute;
average the electronic feedback from the at least one jury user and display the averaged feedback on a plaintiff user interface and a defendant user interface;
allow the plaintiff user to enter a plaintiff settlement amount on the plaintiff user interface;
allow the defendant user to enter a defendant settlement amount on the defendant user interface; and
notify the plaintiff user and defendant user if the plaintiff settlement amount and defendant settlement amount cross such that a settlement amount is reached.

2. The system of claim 1, wherein the electronic feedback is a moveable icon positioned along a sliding scale.

3. The system of claim 2, wherein the average calculation is based on the average position of the icon along the sliding scale.

4. The system of claim 1, wherein the system:
receives a third audio and video feed from an arbitrator user;
displays the first feed, second feed, and third feed on the plaintiff user interface, the defendant user interface, and the arbitrator user interface; and
displays the real time plaintiff settlement amount, the real time defendant settlement amount, and the averaged feedback on the arbitrator user interface.

5. A system for providing online dispute resolution, comprising:
at least one processor;
a database for storing a plurality of information including information on at least one dispute; and
a computer-readable storage medium storing one or more sequences of instructions which, when read by the at least one processor, causes the system to:
receive a first audio and video feed from a plaintiff user;
receive a second audio and video feed from a defendant user;
receive a third audio and video feed from an arbitrator user;
display the first feed, second feed, and third feed on a plaintiff user interface, a defendant user interface, and an arbitrator user interface;
allow the plaintiff user to enter a real time plaintiff settlement amount on the plaintiff user interface;
allow the defendant user to enter a real time defendant settlement amount on the defendant user interface; and
display both the real time plaintiff settlement amount and the real time defendant settlement amount on the arbitrator user interface.
